(19) United States
(12) Patent Application Publication
(10) Pub. No.: US 2016/0253111 A1
(43) Pub. Date: Sep. 1, 2016

(54) STORAGE DEVICE AND STORING METHOD

(71) Applicant: KABUSHIKI KAISHA TOSHIBA, Tokyo (JP)

(72) Inventors: Minoru Yamamoto, Kawasaki Kanagawa (JP); Masakazu Kitahara, Kunitachi Tokyo (JP); Kiyotaka Sasaki, Kawasaki Kanagawa (JP); Seiji Inamura, Kawasaki Kanagawa (JP)

(21) Appl. No.: 14/740,601

(22) Filed: Jun. 16, 2015

Related U.S. Application Data
(60) Provisional application No. 62/121,804, filed on Feb. 27, 2015.

(51) Int. Cl. G06F 3/06; G06F 12/08

(52) U.S. Cl. CPC G06F 3/0619; G06F 3/0629; G06F 3/0676; G06F 12/0875; G06F 2212/60

(57) ABSTRACT

According to one embodiment, a storage device is provided which includes a control unit configured to, in case that first data coincides with third data out of second data of a second size greater than the first size stored on a storage medium, do not write fourth data obtained by replacing the third data included in the second data with the first data onto the storage medium.

### CROSS-REFERENCE TO RELATED APPLICATIONS

This application is based upon and claims the benefit of priority from U.S. Provisional Application No. 62/121,804, filed on Feb. 27, 2015; the entire contents of which are incorporated herein by reference.

### FIELD

Embodiments described herein relate generally to a storage device and storing method.

### BACKGROUND

Storage devices having a storage medium receive a write command instructing to write-data onto the storage medium from an external device such as a host device. In this case, the storage device performs a process of reading out data stored on the storage medium and changing the read-out data according to write-data transferred from the external device to write onto the storage medium (also called read-modify-write).

However, even if receiving write-data that is same as data already stored on the storage medium from the external device, the storage device may perform read-modify-write. When read-modify-write is repeated at the same place, if the storage medium is a magnetic disk, overwriting (partially at the side) of data adjacent to the write-data written on the storage medium or influence of leakage flux when writing data (ATI: Adjacent Track Interference) may occur. Or, if the storage medium is a NAND memory, the degradation of NAND elements due to data writing or data-transfer tightness due to unnecessary write processing may occur.

### BRIEF DESCRIPTION OF THE DRAWINGS

FIG. 1 is a diagram describing schematically an example configuration of a storage device according to a first embodiment;

FIG. 2 is a block diagram describing an example of a functional configuration of an HDC which the storage device according to the first embodiment has;

FIG. 3 is a flow chart describing an example of a process flow of writing write-data onto a disk in the storage device according to the first embodiment;

FIG. 4 is a diagram for illustrating an example of a medium write process by the storage device according to the first embodiment;

FIG. 5 is a diagram for illustrating an example of a medium write process by the storage device according to the first embodiment;

FIG. 6 is a diagram for illustrating another example of a medium write process by the storage device according to the first embodiment;

FIG. 7 is a diagram for illustrating another example of a medium write process by the storage device according to the first embodiment;

FIG. 8 is a diagram for illustrating another example of a medium write process by the storage device according to the first embodiment; and

FIG. 9 is a block diagram describing an example of a functional configuration of a storage device according to a second embodiment.

### DETAILED DESCRIPTION

In general, according to the present embodiment, a storage device is provided which comprises a storage medium; a receiving unit configured to receive, from an external device, first data of a first size to be written onto the storage medium; and a control unit configured to, in case that the first data coincides with third data out of second data of a second size greater than the first size stored on the storage medium, do not write fourth data obtained by replacing the third data included in the second data with the first data onto the storage medium, the third data being stored on a first area which is the destination to write the first data.

The storage devices and storing methods according to embodiments will be described in detail below with reference to the accompanying drawings. The present invention is not limited to these embodiments.

### First Embodiment

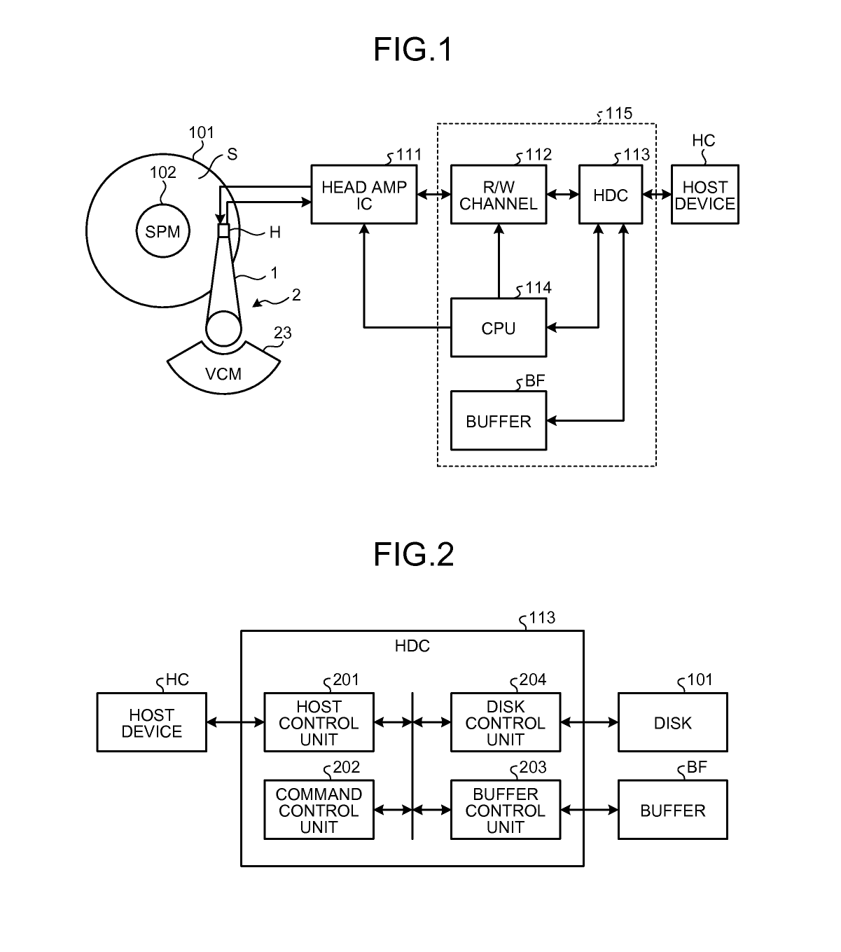

FIG. 1 is a diagram describing schematically an example configuration of a storage device according to the first embodiment. The storage device according to this embodiment is a disk drive device such as a hard disk drive (HDD).

As shown in FIG. 1, in the present embodiment, the storage device has multiple disks 101 that are rotationally driven by a spindle motor 102 and that each have a recording surface S onto which data is recorded. Further, the storage device has multiple heads H respectively provided for the recording surfaces S of the disks 101 and controlled to be positioned with respect to the recording surfaces S. Yet further, the storage device has multiple head suspensions 1 provided respectively for the multiple heads H and that are actuators to drive the heads H. Further, the storage device has a head stack assembly (HSA) 2 that supports the multiple head suspensions 1 and that drives the multiple heads H.

The head H is mounted on the HSA 2 and provided movable in radial directions of the recording surface S of the disk 101. The HSA 2 is rotationally driven by a voice coil motor (VCM) 23 and moves the head H over the recording surface S of the disk 101. The head H has a write head used to write data onto the disk 101 and a read head used to read data from the disk 101.

The storage device has a head amplifier integrated circuit (hereinafter called a head amp IC) 111, a read/write channel (hereinafter called an R/W channel) 112, a hard disk controller (HDC) 113, a central processing unit (CPU) 114, which is an example of a processor, and a buffer BF. In the present embodiment, the R/W channel 112, HDC 113, CPU 114, and buffer BF are incorporated in a one-chip integrated circuit 115.

The head amp IC 111 causes a write signal (current) according to write-data input from the R/W channel 112 to flow through the head H. Further, the head amp IC 111 amplifies a read signal output from the head H (read-data read out from the disk 101 by the head H) and transmits the amplified read signal to the R/W channel 112.

The R/W channel 112 is a signal processing circuit. In the present embodiment, the R/W channel 112 encodes (code modulates) write-data input from the HDC 113 and outputs the encoded write-data to the head amp IC 111. Further, the R/W channel 112 decodes (code demodulates) read-data from the read signal transmitted from the head amp IC 111 and outputs the decoded read-data to the HDC 113.

The HDC 113 is a communication interface that enables communication with a host device HC. Specifically, the HDC 113 exchanges a variety of information with the host device HC such as commands to instruct to write write-data onto the disk 101 (hereinafter called write commands), commands to instruct to read read-data from the disk 101 (hereinafter called read commands), write-data, and read-data.

Here, the write command includes start logical block address (LBA) of logical sectors that are destination to write write-data onto among logical sectors managed in the disk 101, and the write-data length. The read command includes start LBA of logical sectors storing read-data to be read among the logical sectors managed in the disk 101, and the read-data length.

The CPU 114 is a main controller of the storage device and executes various processes such as the control process of writing write-data and reading read-data by the head H, and the servo control process of controlling the position of the head H over the recording surface S of the disk 101. The CPU 114 executes various processes according to programs stored in a storage medium such as a read only memory (ROM). The buffer BF is an example of a read cache to store read-data (cache data) read out from the disk 101.

Here, the process of writing write-data executed in the storage device according to the present embodiment will be described briefly. First, the storage device receives write-data of a first predetermined size (an example of first data) to be written onto the disk 101 (an example of a storage medium) from the host device HC, which is an example of an external device. The first predetermined size is an example of a first size that is a minimum unit in which to exchange data with the host HC. In the present embodiment, the first predetermined size is the size of the logical sector (512 bytes).

Next, the storage device reads out read-data of a second predetermined size (an example of second data) including partial read data (an example of third data) stored on logical sectors (an example of a first area) that are the destination to write write-data onto the disk 101. The second predetermined size is a minimum unit in which to write data onto the disk 101 and is an example of a second size greater than the first size. In the present embodiment, the second predetermined size is the size of a physical sector (4K bytes) and also called a long sector. Then the storage device writes to-be-written data (an example of fourth data) obtained by replacing the partial read data included in the read-out read-data with the write-data onto the disk 101. That is, the storage device according to the present embodiment is a storage device of an advanced format that executes a write process called read-modify-write.

FIG. 2 is a block diagram describing an example of a functional configuration of the HDC which the storage device according to the first embodiment has. As shown in FIG. 2, in the present embodiment, the HDC 113 has a host control unit 201, a command control unit 202, a buffer control unit 203, and a disk control unit 204.

The host control unit 201 is an example of a communicating unit or receiving unit which communicates with the host device HC and exchanges a variety of information such as write commands, read commands, write-data, and read-data with the host device HC in compliance with Peripheral Components Interconnect (PCI) Express Standard, Serial Advanced Technology Attachment (SATA) Standard, Serial Attached SCSI (SAS) Standard, or the like. The command control unit 202 instructs the disk control unit 204 to write write-data onto and read read-data from the disk 101 according to various commands such as a write command and a read command received by the host control unit 201 from the host device HC. The buffer control unit 203 stores read-data read out from the disk 101 as cache data into the buffer BF and reads out cache data stored in the buffer BF. The disk control unit 204 controls writing write-data onto and reading read-data from the disk 101 via the head amp IC 111 and the R/W channel 112.

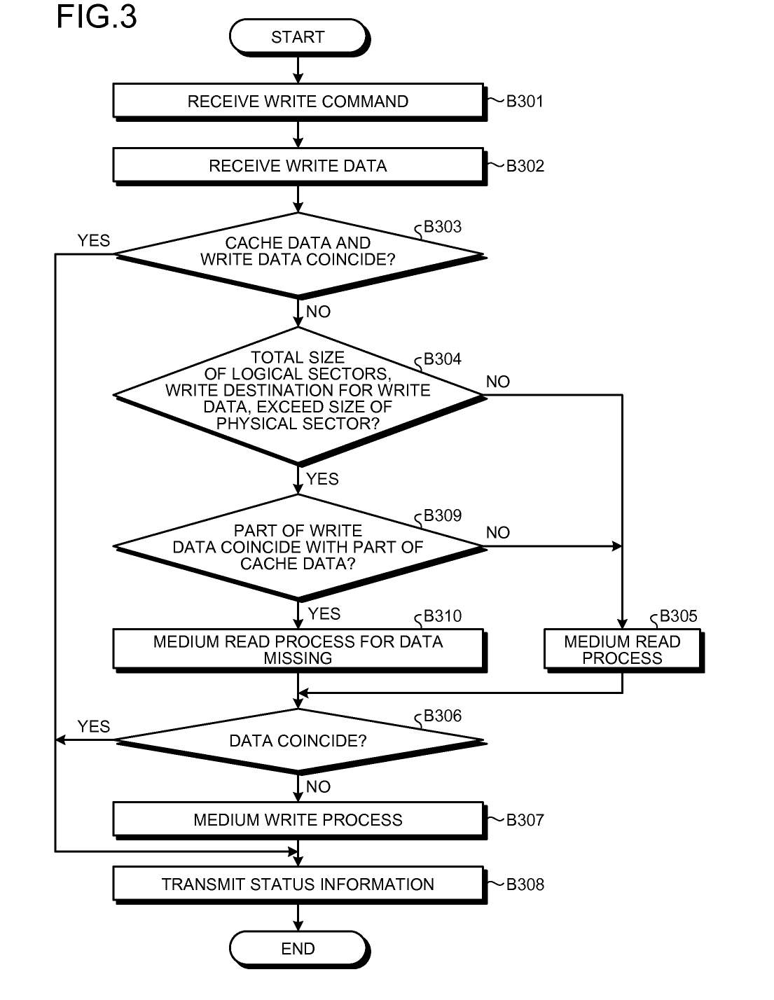

Next, the process of writing write-data onto the disk 101 in the storage device according to the present embodiment will be described using FIG. 3. FIG. 3 is a flow chart describing an example of a process flow of writing write-data onto the disk in the storage device according to the first embodiment.

The host control unit 201 receives a write command from the host device HC (B301). Further, the host control unit 201 receives write-data in minimum units of the size of the logical sector from the host device HC (B302).

When receiving write-data from the host device HC by the host control unit 201, the buffer control unit 203 reads cache data from the buffer BF. Then the disk control unit 204 (an example of a control unit) determines whether the write-data coincides with cache data of the same LBAs as the LBAs of the write-data out of the read cache data (B303). If the write-data does not coincide with the cache data (No at B303), the disk control unit 204 determines whether the total size of logical sectors that are the write destination for the write-data (i.e., the total size of the write-data) exceeds the size of a physical sector (B304).

If the total size of logical sectors that are the write destination for the write-data is smaller than or equal to the size of a physical sector (No at B304), the disk control unit 204 performs a medium read process of reading read-data including partial read data stored on logical sectors that are the write destination for the write-data in a minimum unit of the size of the physical sector from the disk 101 (B305). Then the disk control unit 204 performs a data comparing process of determining whether the partial read data read from the logical sectors specified by the write command (i.e., logical sectors that are the write destination for the write-data), out of the read-data read by the medium read process, coincides with that write-data (B306).

Then if the partial read data does not coincide with the write-data (No at B306), the disk control unit 204 performs a medium write process of writing to-be-written data having the partial read data replaced with (changed by) the write-data onto the disk 101 (B307). Then the disk control unit 204 transmits status information indicating the completion of writing the write-data to the host device HC via the host control unit 201 (B308).

On the other hand, if the partial read data coincides with the write-data (Yes at B306), the disk control unit 204 does not perform the medium write process of writing to-be-written data onto the disk 101 (or it prohibits the execution of the medium write process). Thus, if the read-data read by the medium read process includes partial read data that is the same as the write-data, writing the write-data onto the disk 101 is not performed. Hence, the influence on written data adjacent to the area onto which the write-data would be written and the influence of the ATI due to leakage flux that occurs when writing write-data can be prevented (or suppressed). Further, with assuring writing the write-data onto the disk 101, the status information is transmitted to the host device HC instantaneously, and thus the performance of the storage device can be improved. Next, the disk control unit 204 transmits the status information indicating the completion of writing the write-data to the host device HC via the host control unit 201 (B308).

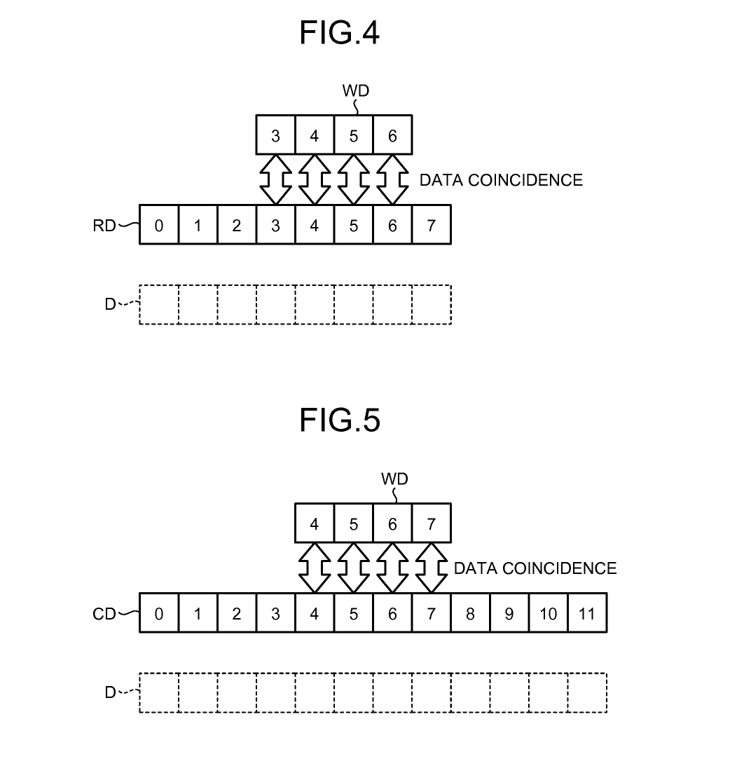

FIG. 4 is a diagram for illustrating an example of a medium write process by the storage device according to the first embodiment. For example, as shown in FIG. 4, the host control unit 201 receives write-data WD to be written onto four logical sectors of from start LBA 3 to end LBA 6. In this case, the disk control unit 204 reads out read-data RD[0-7] stored in seven logical sectors (one physical sector) of LBAs 0 to 7, including the four logical sectors of from start LBA 3 to end LBA 6, from the disk 101. Then, if partial read data RD[3-6] corresponding to logical sectors (of LBAs 3 to 6), which are the write destination for the write-data WD, out of the read-out read-data RD[0-7] coincides with the write-data WD, the disk control unit 204 does not perform the medium write process of writing to-be-written data D onto the disk 101.

Referring back to FIG. 3, also if the cache data and the write-data coincide (Yes at B303), the disk control unit 204 does not perform the medium write process. Thus, if the cache data and the write-data coincide, writing to-be-written data onto the disk 101 is not performed. Hence, the influence on written data around the area onto which the write-data would be written and the influence of the ATI can be prevented (or suppressed). Further, with assuring writing the write-data onto the disk 101, the status information is transmitted to the host device HC instantaneously, and thus the performance of the storage device can be improved. Then the disk control unit 204 transmits the status information indicating the completion of writing the write-data to the host device HC via the host control unit 201 (B308).

FIG. 5 is a diagram for illustrating an example of a medium write process by the storage device according to the first embodiment. For example, as shown in FIG. 5, the host control unit 201 receives write-data WD to be written onto four logical sectors of from start LBA 4 to end LBA 7. In this case, the disk control unit 204 determines whether cache data CD[4-7] corresponding to logical sectors of LBAs 4 to 7 out of cache data CD read by the buffer control unit 203 and the write-data WD coincide. Then, if the cache data CD[4-7] and the write-data WD coincide, the disk control unit 204 does not perform the medium write process of writing to-be-written data D onto the disk 101.

Referring back to FIG. 3, if the total size of logical sectors that are the write destination for the write-data is greater than the size of a physical sector (Yes at B304), the disk control unit 204 determines whether part of the write-data coincides with part of cache data (B309). If part of the write-data does not coincide with part of cache data (No at B309), the disk control unit 204 performs a medium read process of reading data of physical sectors that are the write destination for the write-data (B305). On the other hand, if part of the write-data coincides with part of cache data (Yes at B309), the disk control unit 204 performs a medium read process of reading data (including data missing from the cache data) stored on the physical sector including logical sectors storing the other data not coinciding with part of the cache data out of the received write-data (B310).

Then the disk control unit 204 performs a data compare process of determining whether the read-data read at B305 and the write-data coincide (B306). Or the disk control unit 204 performs a data compare process of determining whether the cache data and the read-data read at B310 coincide with the received write-data (B306). If the read-data read at B305 (or the cache data and the read-data read at B310) does not coincide with the write-data (No at B306), the disk control unit 204 performs the medium write process of writing the write-data as to-be-written data onto the disk 101 (B307). Then the disk control unit 204 transmits the status information indicating the completion of writing the write-data to the host device HC via the host control unit 201 (B308).

On the other hand, if the read-data read at B305 (or the cache data and the read-data read at B310) coincides with the write-data (Yes at B306), the disk control unit 204 does not perform the medium write process of writing the write-data as to-be-written data onto the disk 101. Thus, the influence on written data around the area onto which the write-data would be written and the influence of the ATI can be prevented (or suppressed). Further, with assuring writing the write-data onto the disk 101, the status information is transmitted to the host device HC instantaneously, and thus the performance of the storage device can be improved. Then the disk control unit 204 transmits the status information indicating the completion of writing the write-data to the host device HC via the host control unit 201 (B308).

If the total size of logical sectors that are the write destination for the write-data is larger than the size of a physical sector and if partial write-data (an example of fifth data), which is part of the write-data, coincides with part of the read-data read at B305 (or the cache data and the read-data read at B310), then the disk control unit 204 performs a medium write process of writing only data other than the partial write data out of the write-data as to-be-written data onto the disk 101. In other words, the disk control unit 204 does not write the partial write data out of the write-data onto the disk 101. As such, if the total size of logical sectors that are the write destination for the write-data is larger than the size of a physical sector and if the partial write data coincides with part of the read-data read by the medium read process, the process of writing all the write-data onto the disk 101 is not performed. Thus, the influence on written data around the area onto which the write-data would be written and the influence of the ATI can be prevented (or suppressed).

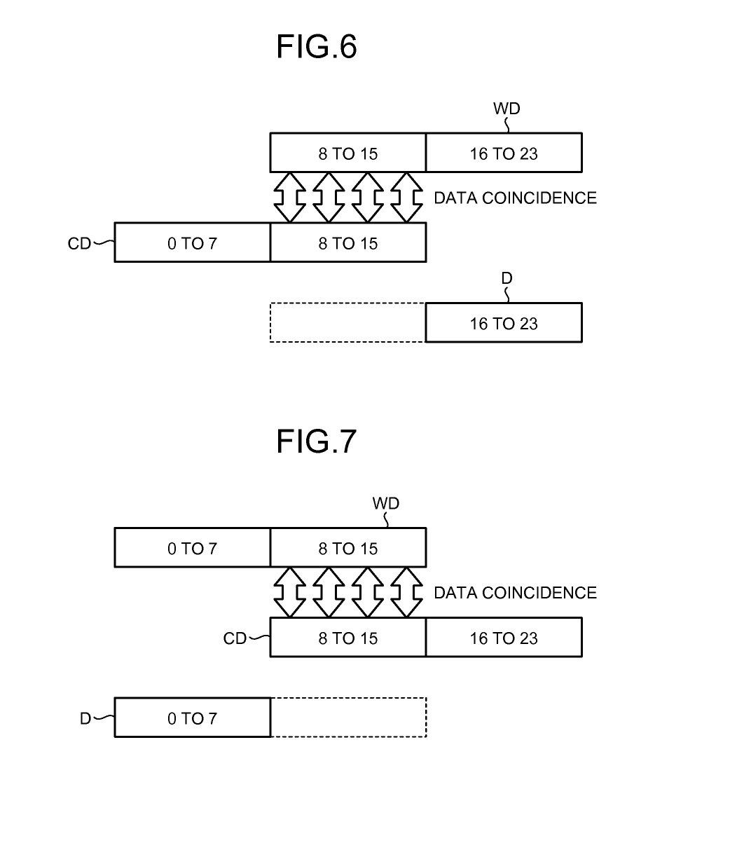

Here, a specific example of the medium write process in the case where the partial write data coincides with cache data CD read from the buffer BF or read-data RD read from the disk 101 will be described using FIGS. 6 to 8. FIGS. 6 to 8 are diagrams for illustrating another example of a medium write process executed by the storage device according to the first embodiment.

An example where write-data WD for LBAs 8 to 23 has been received will be described using, e.g., FIG. 6. Here, it is supposed to write and read-data in minimum units of eight sectors (eight LBAs) onto and from the disk 101. That is, the received write-data WD is to be written onto two physical sectors of the disk 101. If partial write data WD[8-15] for LBAs 8 to 15 out of the write-data WD coincides with cache data CD[8-15] (or read-data RD[8-15]), then the disk control unit 204 performs the medium write process of writing only data other than the partial write data WD[8-15] (i.e., partial write data WD[16-23]) out of the write-data WD as to-be-written data D onto the disk 101.

Next, an example where write-data WD for LBAs 0 to 15 has been received will be described using, e.g., FIG. 7. If partial write data WD[8-15] for LBAs 8 to 15 out of the write-data WD coincides with cache data CD[8-15] (or read-data RD[8-15]), then the disk control unit 204 performs the medium write process of writing only data other than the partial write data WD[8-15] (i.e., partial write data WD[0-7]) out of the write-data WD as to-be-written data D onto the disk 101.

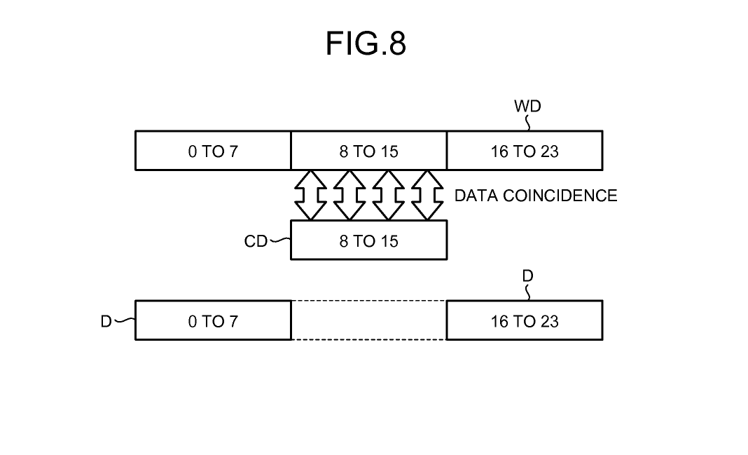

Next, an example where write-data WD for LBAs 0 to 23 has been received will be described using, e.g., FIG. 8. If partial write data WD[8-15] for LBAs 8 to 15 out of the write-data WD coincides with cache data CD[8-15] (or read-data RD[8-15]), then the disk control unit 204 performs the medium write process of writing only data other than the partial write data WD[8-15] (i.e., partial write data [0-7, 16-23]) out of the write data WD as to-be-written data D onto the disk 101.

According to the first embodiment, if write-data received from the host device HC and read-data read out from the disk 101 coincide, writing to-be-written data having the read-data replaced with the write-data onto the disk 101 is not performed. Further, according to the first embodiment, if the write-data and cache data coincide, writing the to-be-written data onto the disk 101 is not performed. Yet further, according to the first embodiment, partial write data coinciding with the read-data out of the write-data is not written onto the disk 101. As a result, the effect can be obtained that the influence on written data around the area onto which the write-data would be written and the influence of the ATI can be prevented (or suppressed). Further, with assuring writing the write-data onto the disk 101, the status information is transmitted to the host device HC instantaneously, so that the effect can be obtained that the performance of the storage device can be improved.

### Second Embodiment

The second embodiment is an example of a storage device such as a solid state drive comprising a nonvolatile memory such as a NAND flash memory as an example of a storage medium. In the description below, a description of the same configuration as in the first embodiment is omitted.

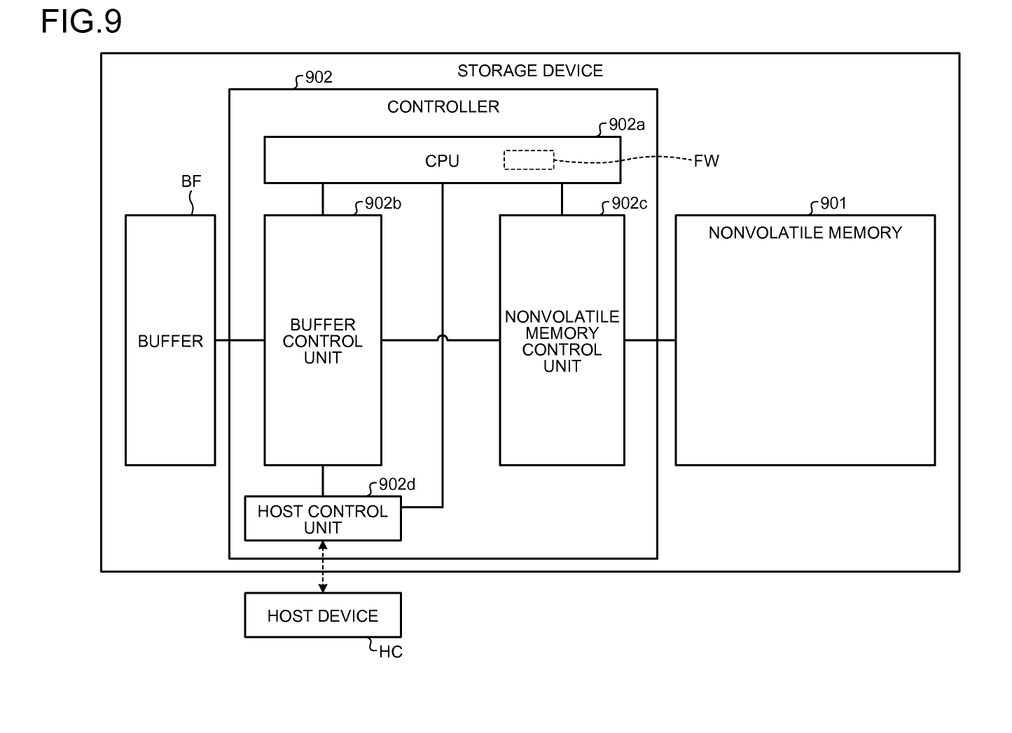

FIG. 9 is a block diagram describing an example of a functional configuration of a storage device according to the second embodiment. The storage device according to the present embodiment is also a storage device of the advanced format that executes so-called read-modify-write like the storage device according to the first embodiment. As shown in FIG. 9, the storage device according to the present embodiment has a nonvolatile memory 901 such as a NAND flash memory, a controller 902 that controls the entire storage device, and a buffer BF.

The controller 902 controls the entire storage device. The controller 902 has a CPU 902a, a buffer control unit 902b, a nonvolatile memory control unit 902c, and a host control unit 902d.

The nonvolatile memory 901 is an example of a storage medium in which data is recorded. The buffer memory BF is an example of a read cache that stores a variety of information such as write-data, read-data, write commands, and read commands, which are exchanged between the host device HC and the controller 902.

The CPU 902a of the controller 902 controls the constituents in the controller 902 overall. In the present embodiment, the CPU 902a controls the functions of the controller 902 by executing firmware FW.

The buffer control unit 902b is controlled by the CPU 902a to store read-data read out from the nonvolatile memory 901 as cache data into the buffer BF and to read cache data stored in the buffer BF. The nonvolatile memory control unit 902c is controlled by the CPU 902a to control data transfer between the nonvolatile memory 901 and the buffer memory BF. The nonvolatile memory control unit 902c (an example of a control unit) controls writing write-data into and reading read-data from the nonvolatile memory 901.

The host control unit 902d is an example of a communicating unit or receiving unit which communicates with the host device HC and receives a variety of information such as read commands, write commands, and write-data from the host device HC and transmits a variety of information such as read-data and status information to the host device HC in compliance with PCI Express Standard, SATA Standard, SAS Standard, or the like.

The nonvolatile memory control unit 902c according to the present embodiment performs the process of writing write-data into the nonvolatile memory 901, which is an example of a storage medium, according to the process flow shown in FIG. 3 like the disk control unit 204 of the storage device according to the first embodiment.

According to the second embodiment, as in the first embodiment, if write-data received from the host device HC and read-data read out from the nonvolatile memory 901 coincide, writing to-be-written data having the read-data replaced with the write-data into the nonvolatile memory 901 is not performed. As a result, the effect can be obtained that the degradation of NAND elements due to write-data writing and data-transfer tightness due to unnecessary write processing can be prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a storage medium;
a receiving unit configured to receive, from an external device, first data of a first size to be written onto the storage medium; and
a control unit configured to, in case that the first data coincides with third data out of second data of a second size greater than the first size stored on the storage medium, do not write fourth data obtained by replacing the third data included in the second data with the first data onto the storage medium, the third data being stored on a first area which is the destination to write the first data.

2. The storage device of claim 1, wherein upon receipt of the first data, the control unit reads out the second data.

3. The storage device of claim 1, wherein the control unit determines whether the first data and the third data coincide.

4. The storage device of claim 3, wherein in case that determining that the first data and the third data coincide, the control unit does not write the fourth data onto the storage medium.

5. The storage device of claim 3, wherein in case that determining that the first data and the third data do not coincide, the control unit writes the fourth data onto the storage medium.

6. The storage device of claim 1, further comprising a read cache configured to store data read from the storage medium,
wherein in case that the first data coincides with data stored in the read cache, the control unit does not write the fourth data onto the storage medium.

7. The storage device of claim 6, wherein the control unit determines whether the first data coincides with data stored in the read cache.

8. The storage device of claim 7, wherein in case that determining that the first data does not coincide with data stored in the read cache, the control unit reads out the second data.

9. The storage device of claim 1, wherein in case that the total size of the first data is greater than the second size and that fifth data that is part of the first data coincides with part of the second data, the control unit writes data other than the fifth data out of the first data onto the storage medium.

10. The storage device of claim 9, wherein the control unit determines whether the total size of the first data is greater than the second size.

11. A storing method comprising:
Receiving, from an external device, first data of a first size to be written onto a storage medium; and
in case that the first data coincides with third data out of second data of a second size greater than the first size stored on the storage medium, not writing fourth data obtained by replacing the third data included in the second data with the first data onto the storage medium, the third data being stored on a first area which is the destination to write the first data.

12. The storing method of claim 11, further comprising:
upon receipt of the first data, reading out the second data.

13. The storing method of claim 11, further comprising: determining whether the first data and the third data coincide.

14. The storing method of claim 13, further comprising: in case that determining that the first data and the third data coincide, not writing the fourth data onto the storage medium.

15. The storing method of claim 13, further comprising: in case that determining that the first data and the third data do not coincide, writing the fourth data onto the storage medium.

16. The storing method of claim 11, further comprising: in case that the first data coincides with data stored in a read cache, not writing the fourth data onto the storage medium.

17. The storing method of claim 16, further comprising: determining whether the first data coincides with data stored in the read cache.

18. The storing method of claim 17, further comprising: in case that determining that the first data does not coincide with data stored in the read cache, reading out the second data.

19. The storing method of claim 11, further comprising: in case that the total size of the first data is greater than the second size and that fifth data that is part of the first data coincides with part of the second data, writing data other than the fifth data out of the first data onto the storage medium.

20. The storing method of claim 19, further comprising: determining whether the total size of the first data is greater than the second size.
